(19) United States
(12) Patent Application Publication
(10) Pub. No.: US 2006/0053682 A1
(43) Pub. Date: Mar. 16, 2006

(54) Corner-fitting escape-proof repeating animal trap

(76) Inventor: Michael Goldstein, Lititz, PA (US)

Correspondence Address: JACOBSON HOLMAN;PROFESSIONAL LIMITED LIABILITY COMPANY, 400 SEVENTH STREET, N.W., WASHINGTON, DC, 20004, US

(21) Appl. No.: 11/224,305

(22) Filed: Sep. 13, 2005

Related U.S. Application Data
(60) Provisional application No. 60/608,883, filed on Sep. 13, 2004.

(51) Int. Cl. A01M 23/08

(52) U.S. Cl. 43/67; 43/65

(57) ABSTRACT

A corner-fitting escape-proof repeating animal trap having a housing and two inclined plane trap assemblies arranged generally at right angles to one another within the housing. The housing includes a cover and a base defining an enclosure having five upstanding peripheral walls and a floor. Two ledged mounting wells are provided in the floor for securing the two trap assemblies in the enclosure, with two rectangular openings being formed in two of the walls to provide access to the trap assemblies. Formed in the inner surface of the molded cover is a pair of protrusions positioned so as to respectively engage with the tops of the trap assemblies when the cover is closed. The outer surface of the floor includes raised portions which, in conjunction with a ridge on the outer edge of the floor, define adjacent recesses that cooperate with protuberances on the outer top surface of the cover of another housing for non-sliding engagement therewith when two trap units are placed in a stacked relationship.

This application is entitled to and hereby claims the priority of co-pending U.S. Provisional application, Ser. No. 60/608,883 filed Sep. 13, 2004.

### BACKGROUND OF THE INVENTION

1. Field of the Invention

This invention relates to repeating animal traps and, more particularly, to a corner-fitting escape-proof animal trap of the inclined plane type adapted to catch and confine a number of targeted animals while automatically resetting itself.

Although the concepts of the instant invention are equally applicable to traps for animals of any size, devices of this type are primarily utilized in connection with the trapping of rodents such as mice and rats and, therefore, further discussion herein will be primarily directed to this application.

2. Description of the Prior Art

Repeating animal traps are well known. The commercial embodiment's of such traps currently available include a housing defining an enlarged enclosure with one, or perhaps two, inclined plane trap assemblies communicating the interior of the enclosure with the exterior of the housing via an elongated passageway. An inclined plane tilting floor member is positioned in the passageway of each trap assembly and is adapted to lift a door to block an entrance opening when the rodent passes beyond a pivot point thereby limiting escape from the enclosure. When the rodent exits the passageway into the enclosure, the door falls by gravity on the entrance end of the tilting floor to reset the trap and the raised end of the tilting floor limits the ability of captured rodent to return to the passageway.

To prevent captured rodents from escaping by grasping the inner end of the tilting floor to regain access to the passageway, an escape-proof inclined plane trap assembly has been developed and is fully disclosed in U.S. Pat. Nos. 6,662,442 and 6,694,669; the disclosures of both patents are incorporated by reference as if fully set forth herein. The escape-proof inclined plane trap assemblies of these patents are disclosed in various embodiments within an outer housing that is generally rectangular for placement along a wall. Two inclined plane trap assemblies are placed in alignment, with their respective entrance openings being juxtaposed to the same wall, but on opposite sides of the trap.

As it is a well known tendency of mice and rats to stay close to walls in a room, rather than running into the open, the traps disclosed in the aforesaid patents are well suited to many positions in a room. However, a need exists for a similar trap assembly that can be placed in the corner of a room when that is the most convenient location for implementing a rodent capture device.

U.S. Pat. No. 5,040,327 discloses a polygonal bait station that can be placed against a corner. However, this bait station lacks any capability for retaining the rodents, rendering it ineffective for rodent control unless the rodents entering the station consume a sufficient quantity of the poisoned bait that is contained therein. Furthermore, as it is intended that the poisoned rodents leave the bait station to die elsewhere, undesirable odors and hazardous health conditions may result in those areas to which the sick rodents retreat. Thus, a need exists for a trap mechanism that fits conveniently in a corner to capture unwanted pests and then fully retains them so that they may be subsequently and completely removed from the area.

### SUMMARY OF THE INVENTION

It is an object of this instant invention to provide a repeating animal trap incorporating features that render the same essentially escape-proof while being specifically designed for placement in the corner of a room.

Another object of this invention is the provision of a generally triangular housing of molded plastic with two truncated corners provided with entrance openings and having structural elements for securing two inclined plane trap assemblies in a generally perpendicular relationship therein so that entry to the trap unit may be obtained through the entrance openings from either of two walls converging in a room corner.

A further object of the present invention is to provide a repeating animal trap for corner use that includes specific design features that facilitate stacking of multiple traps in packaging for transport and storage.

Yet another object of the present invention is to provide a repeating animal trap of the type described wherein the housing can be formed of plastic in any conventional manner to enable various structural features to be readily incorporated therein at minimal cost.

A still further object of the present invention is to provide a pest trap having a replaceable adhesive element or glue board for securing both animal and insect pests within the trap enclosure.

In accordance with these and other objects, the present invention is directed to a corner-fitting escape-proof repeating animal and pest trap including a housing and two inclined plane trap assemblies arranged generally at right angles to one another within the housing. The housing includes a base and a cover. The base of the housing preferably has a molded plastic construction forming a floor and five upstanding peripheral walls which define an enclosure. Two ledged mounting wells are provided in the floor for securing the two trap assemblies, respectively, in the enclosure. Two rectangular openings of a size suitable for entry of the target rodent are provided in two of the walls to provide access to the two trap assemblies, respectively. The enclosure may also be accessed by insect pests through one or more apertures in one of the peripheral walls which, in conjunction with an adhesive element or glue board fitted within the enclosure, make the inventive trap effective not only for rodents but also for insect capture and removal as well.

The inner surface of the molded cover has formed therein a pair of protrusions positioned so as to respectively engage with the tops of the trap assemblies when the cover is closed. The outer surface of the floor includes raised portions corresponding with the wells on the inner surface of the floor. These raised portions, in conjunction with a ridge on the outer edge of the floor, define adjacent recesses which cooperate with corresponding protuberances on the outer top surface of the cover of another housing for non-sliding engagement therewith when two trap units are placed in a stacked relationship.

In summary, the repeating animal trap of this invention is simple and inexpensive to manufacture and to maintain and yet, is highly efficient in operation, fitting conveniently in the corner of a room and effectively precluding escape of a pest once it has entered the trap.

These and other objects of the invention, as well as many of the intended advantages thereof, will become more readily apparent when reference is made to the following description taken in conjunction with the accompanying drawings.

### BRIEF DESCRIPTION OF THE DRAWINGS

The combination of elements, arrangement of parts and features of construction that lead to the inventive corner-fitting repeating animal trap of the instant invention will be pointed out in more detail hereinafter with respect to the accompanying drawings wherein:

FIG. 1 is a perspective view of a corner-fitting, escape-proof, repeating rodent trap, in accordance with the present invention;

FIG. 2 is a perspective view of the fully assembled corner-fitting trap of FIG. 1, shown with the cover of the housing in an open position;

FIG. 3 is a longitudinal cross-sectional view of one of the inclined plane trap assemblies of the repeating animal trap of FIG. 1 showing the pivotable floor and door members in an “open” or reset position providing access to the trap passageway from the exterior of the housing through an entrance opening; and

FIG. 4 is a view similar to FIG. 3, with the floor and door members moved to a “closed” position by the weight of a rodent on the inner end portions of the floor member.

FIG. 5 is a top perspective view of the molded housing base of the trap of FIG. 1;

FIGS. 6A-6D are illustrations of a glue board insert for use within the corner-fitting trap according to the present invention;

FIG. 7 is a bottom perspective view of the molded housing cover of FIG. 1;

FIG. 8 is an enlarged top perspective view of the latching mechanism securing the molded housing cover to the molded housing base when the trap is closed as in FIG. 1;

FIG. 9 is a top perspective view of the molded housing cover of the trap of FIG. 7;. and

FIG. 10 is a bottom perspective view of the molded housing base of FIG. 5.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

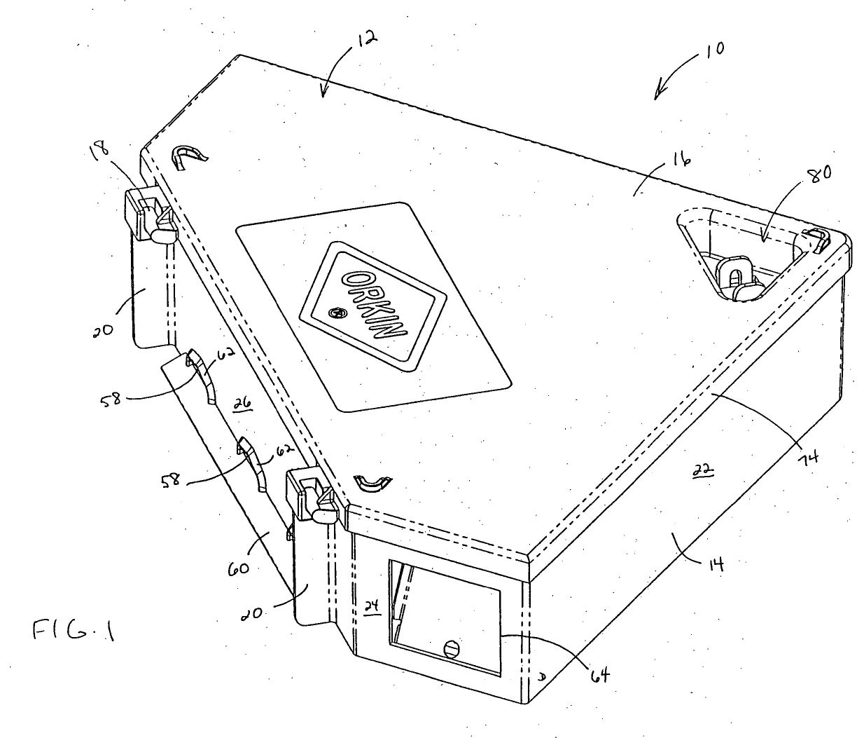

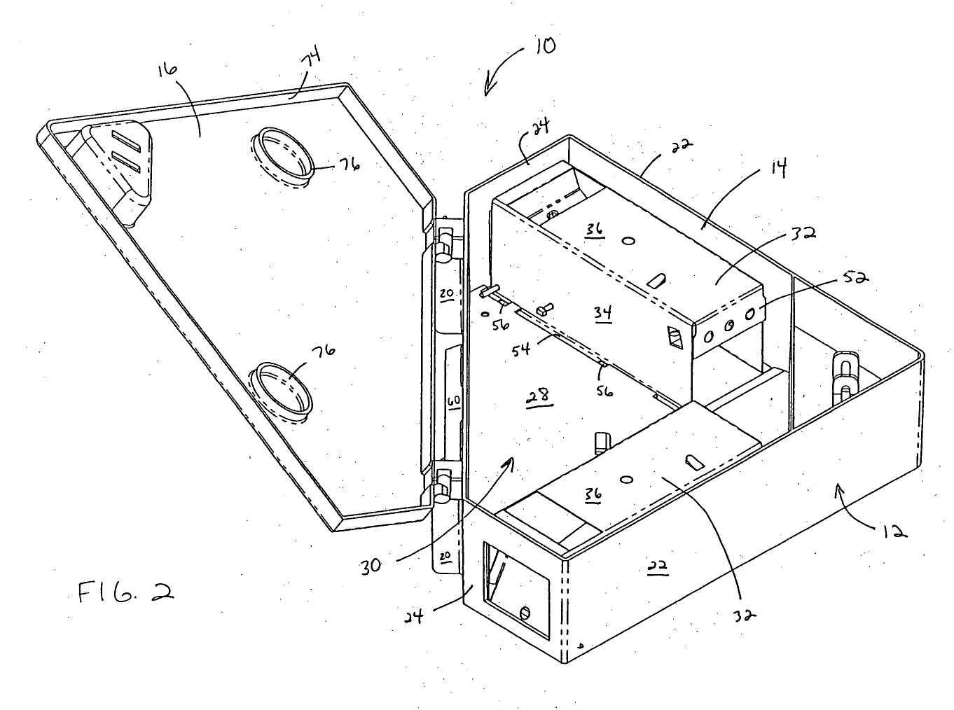

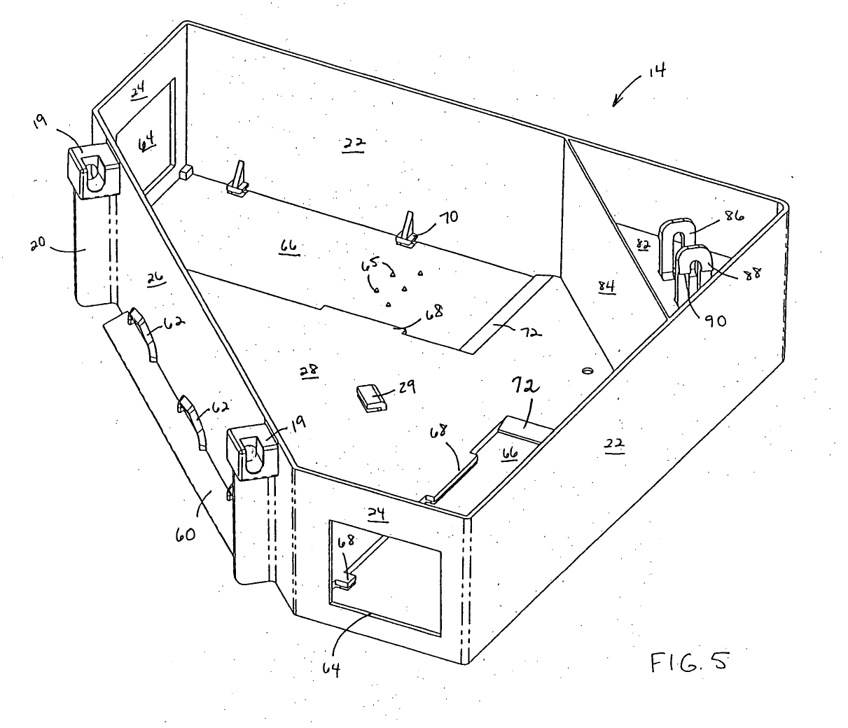

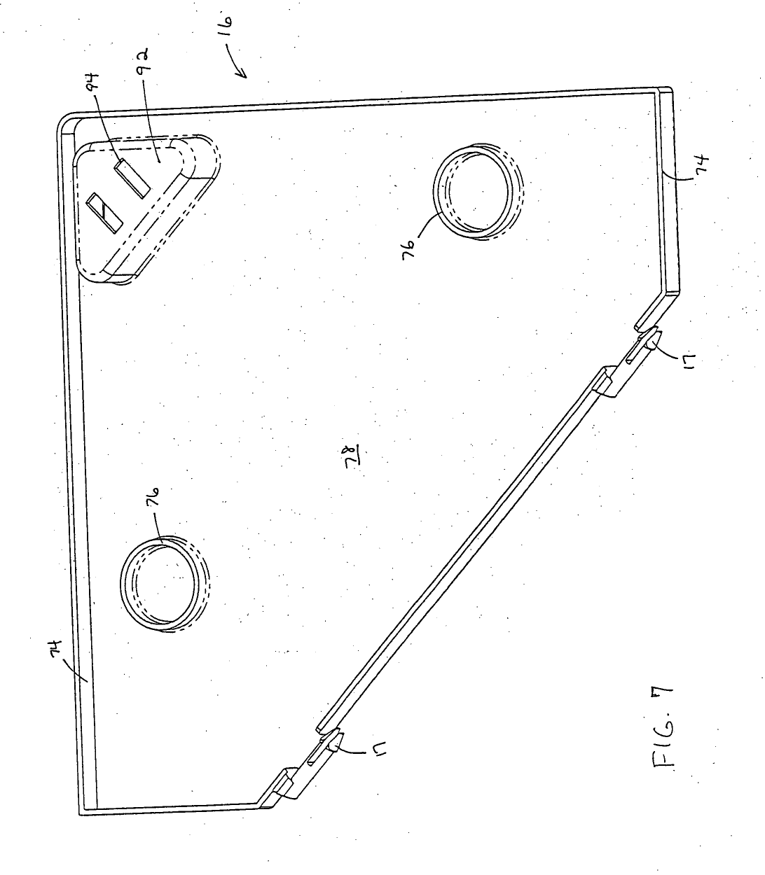

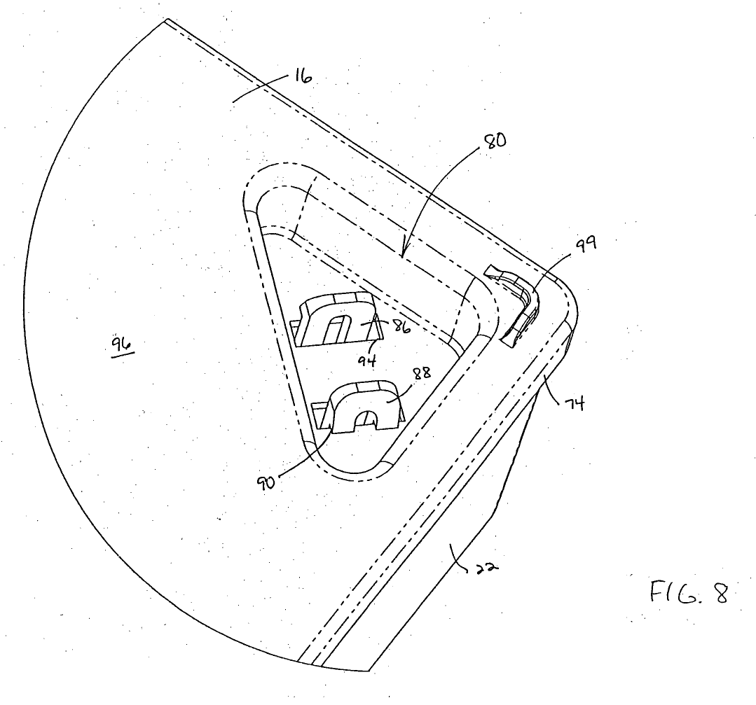

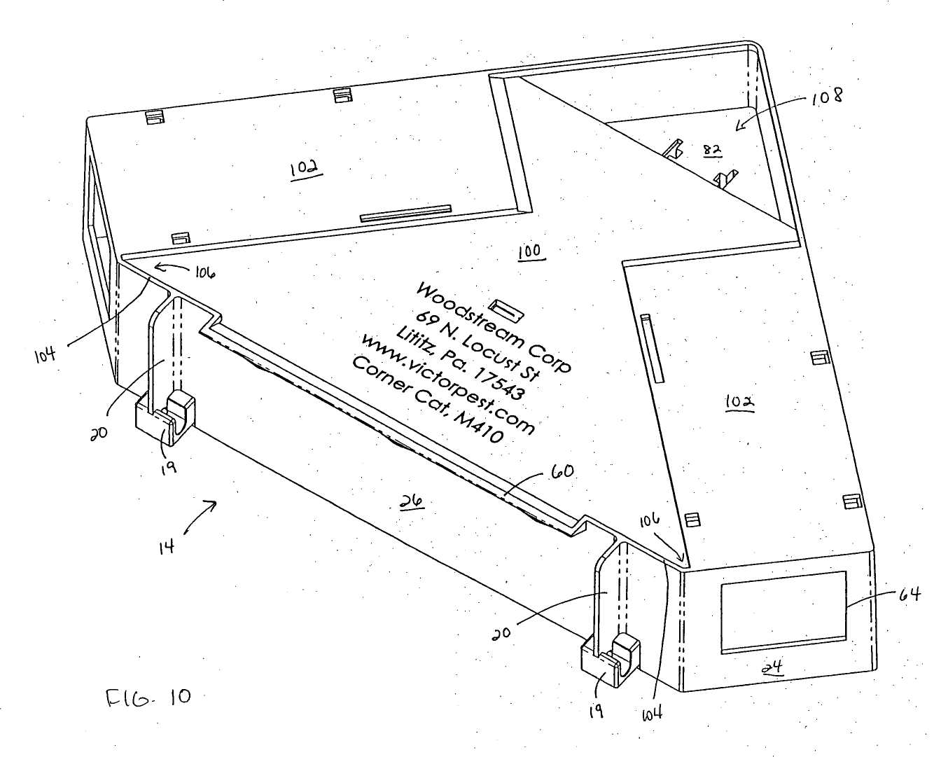

Referring now to the drawings, and more particularly to FIGS. 1 and 2, the pest trap according to the present invention, generally designated by the reference numeral 10, includes a housing, generally designated by the reference numeral 12, having a base 14 and a hinged cover 16 connected thereto so that the cover 14 can be readily opened and closed. The hinges 18 are supported on the tops of vertical gussets 20 which provide reinforcement and protection for the protruding hinges 18. The gussets also act as a stop for the cover 16 when in the fully opened position, thus preventing the cover 16 from contacting the ground. The hinges preferably have a snap-fit construction in which cover-mounted male members 17 having a split conical head (see FIGS. 7 and 9) are inserted into apertures in female base members 19 (see FIGS. 5 and 10).

The base 14 of the housing 12 includes two front peripheral walls 22, two side peripheral walls 24, a rear wall 26, and a floor 28 which, together with the cover 16, define an enclosure, generally designated by the reference numeral 30, for retaining one or more captured pests.

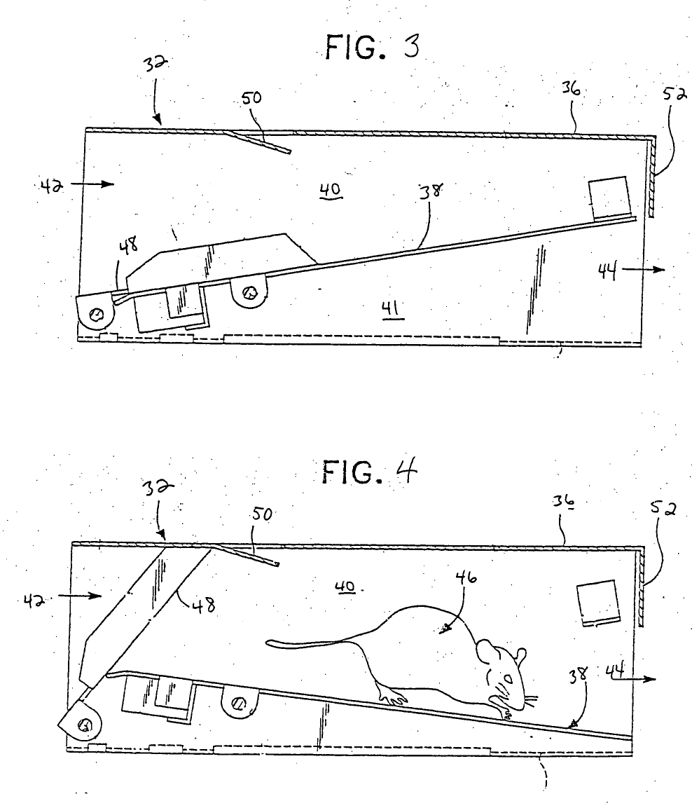

Rodents are captured using two inclined plane trap assemblies 32 of a type described in U.S. Pat. Nos. 6,662,442 and 6,694,669, previously incorporated herein by reference, which fit within the base of the housing. As generally illustrated in FIGS. 3 and 4, each trap assembly 32 includes sides 34 and a roof 36 which, together with a portion of the floor of the housing and an inclined plane member 38, define an elongated passageway 40. At one end of the passageway 40 is an entrance opening 42 communicating with the exterior of the housing and, at the other end of the passageway, is an exit opening 44 communicating with the enclosure 30 defined by the housing 12. A rodent 46 entering the trap assembly 32 moves over the door member 48 and along the inclined plane member 38 until its weight moves the plane member 38 from a first position, shown in FIG. 3, to a second position, shown in FIG. 4. In the second position, the entrance opening 42 is blocked by the door member 48, whose rearward edge is shielded from the rodent 46 by a lip 50, thus preventing rodent escape back through opening 42. With no other outlet, the rodent passes beneath the flange 52 of the roof 36 to exit the trap assembly 32 through the exit opening 44, whereupon the plane member 38 returns to its “reset” first position.

In addition to the roof flange 52, the lower edge of each side of the trap assembly includes a generally perpendicular flange 54 provided with one or more cutouts 56 to facilitate securing of the trap 32 within the housing 12, as will be described more fully hereinafter.

In that the present invention is a live animal trap, a plurality of apertures 58 may be defined in the rear wall 26, or other locations, to provide an air supply to the enclosure 30 until the animals are to be removed from the housing 12. These apertures also serve as access portals for insects such as ants, roaches, etc., as will be discussed more fully hereinafter.

The vertical gussets 20 are also molded into or attached to the rear wall 26. A tapered ledge 60 extends outwardly from the base of the rear wall 26 beneath the apertures 58 for improved stability of the housing 12, to provide a “ramp” making it easier for insects to enter through the apertures, and to reduce any opportunity for captured rodents to gnaw around the bottom of the apertures 58 in an effort to escape. Similarly, the upper and side edges of the apertures 58 are also reinforced with a protruding edge 62 to make gnawing more difficult and to increase the time that would be necessary to chew through the added bulk of reinforcing material.

Two rectangular openings 64 of a size suitable for entry of the target rodent are respectively provided in the two side walls 24 to provide access to a corresponding trap assembly 32 positioned immediately adjacent each opening. As shown in FIG. 2, the trap assemblies 32 are positioned with their length being generally parallel with the front walls 22, with the exit 44 of each trap assembly opening into the enclosure 30 within the housing 12.

As shown in FIG. 5, two ledged mounting wells 66 are provided in the floor 28 of the base 14, preferably integrally molded therewith, for securing the two trap assemblies 32, respectively, in the housing 12. The trap assemblies 32 fit within the wells 66 and are secured therein through placement of the flanges 54 under corresponding ledges 68, 70 in the well perimeter, as may be seen in FIG. 2, with the cutouts 56 in the flanges 54 facilitating such placement. While the side edges and entrance end of well 66 are generally perpendicular relative to the base of the well, the exit end 72 of the well 66 is tapered to provide an easier transition for the rodent as it leaves the surface of the plane member 38 to enter the enclosure 30.

As previously noted, once the rodent is in the enclosure, the plane member 38 returns to it “reset” first position, shown in FIG. 3. To discourage the rodent from entering and perhaps nesting in the space 41 under the plane member, which would likely interfere with the subsequent operation of the trap assembly, upstanding barrier elements 65 are preferably formed in the well 66. These barrier elements 65, which may vary in number and spacing, are preferably pointed or even sharp so as to create an uncomfortable surface that rodents will find unpleasant, thus keeping the space 41 unobstructed.

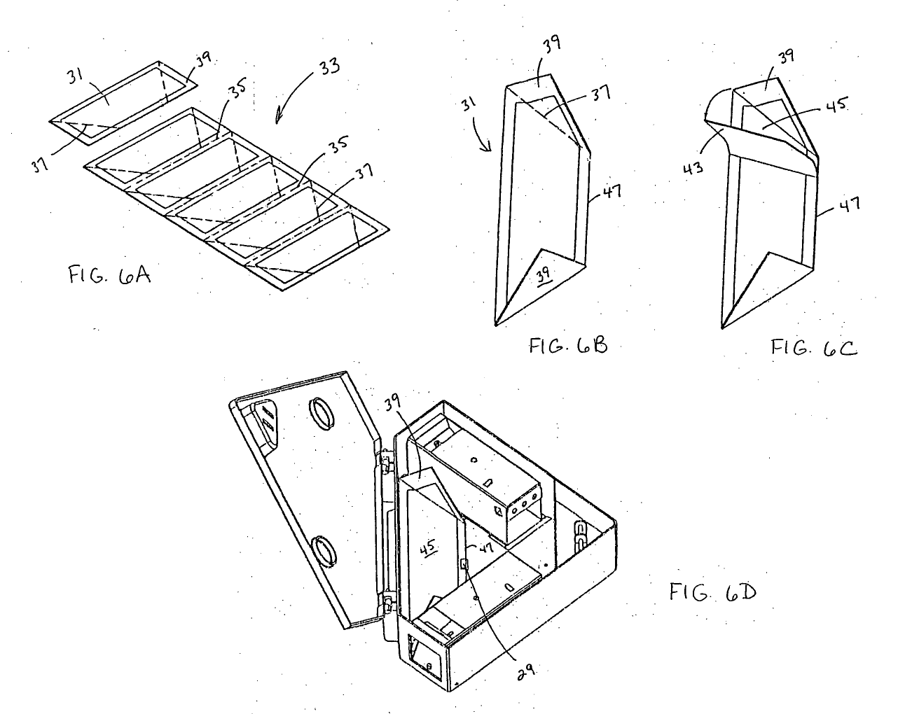

As a further structure for controlling rodent movement within the enclosure, an offset 29 is formed in a generally central location of the trap floor 28 to receive a glue board insert 31, as shown in FIGS. 6A-6D. The glue board insert 31 is provided with the trap 10 as part of a tear-off sheet, generally designated by the reference numeral 33, of glue board inserts 31 joined along perforation lines 35, as shown in FIG. 6A. Each glue board insert has corner perforation lines 37 which, preparatory to insertion of the insert into the trap, facilitate upward folding of the corners 39, as shown in FIG. 6B. The release paper 43, which covers the adhesive surface 45, is then peeled off as indicated in FIG. 6C, and the insert is placed on the floor 28 with the front edge 47 secured under the offset 29, as shown in FIG. 6D. Once in place, the adhesive surface 45 of the glue board insert 31 snares not only incoming rodents but also insects entering the enclosure through the apertures 58. As would be understood by persons of ordinary skill in the art, the glue board insert may be easily removed and replaced with another insert from the tear-off sheet 33 as necessary.

The cover 16 includes a lip 74 extending around the periphery thereof and a pair of protrusions 76 formed on the inner surface 78. These protrusions 76, in addition to the mounting wells 66 and flange-securing ledges 68, 70 already discussed above, act to further secure the trap assemblies 32 in position when the cover 16 is closed by applying downward pressure on the roof 36 of each of the trap assemblies 32. While the protrusions 76 are shown in FIGS. 2 and 7 as being generally cylindrical, the shape thereof may be varied without altering the securing function being performed by such protrusions.

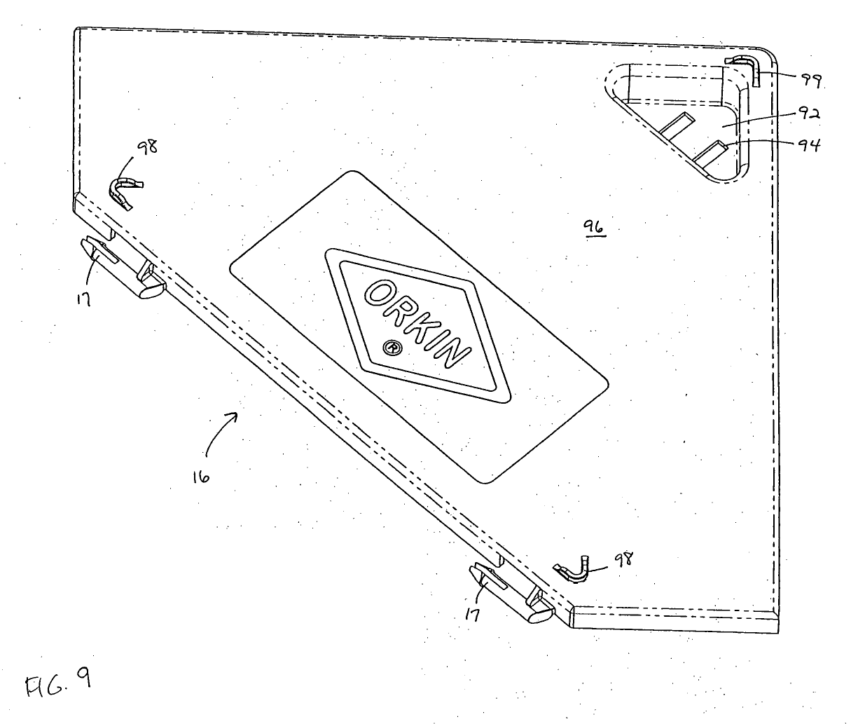

When the cover 16 is closed, as shown in FIGS. 1 and 8, the lip 74 overhangs the upper edge of the walls of the base to ensure a fully “sealed” enclosure, i.e., one in which the rodent cannot squeeze through a gap between the cover 16 and the base 14. To secure the cover 16 to the base 14 in such closed position, these components are further provided with cooperative elements that together form a latching mechanism, generally designated by the reference numeral 80.

More specifically and as best seen in FIG. 5, adjacent the front corner of the base 14, the front walls have an adjoining shelf 82 enclosed and buttressed by a retaining wall 84. Upwardly projecting from the shelf 82 are two spaced fastening elements 86, each having a tapered end 88 defining an outwardly-facing shoulder 90. In a corresponding position on the inner surface 78 of the cover 16, depicted in FIG. 7, a generally triangular latching base 92 having slots 94 therein protrudes so as to extend toward the shelf 82. The tapered ends 88 of the fastening elements 86 extend through the slots 94 until they “snap” into place, being secured within the slots 94 by the shoulders 90 to effect a locking closure of the housing 12 (see FIG. 8). To open the cover 16, force must be applied to press the fastening elements 86 toward one another, thereby releasing the shoulders 90 and allowing the fastening elements 86 to be withdrawn from the slots 94.

As shown in FIGS. 9 and 10, respectively, the outer surface 96 of the cover 16 includes spaced protuberances 98, 99. The outer surface 100 of the floor 28 includes raised portions 102, corresponding with the wells 66 on the inner floor surface that, in conjunction with ridges 104 on the outer edges of the outer surface 100 of the floor 28 adjacent the vertical members 20, define adjacent recesses 106. The recesses 106 are positioned so as to cooperate with the protuberances 98. Similarly, the recess 108 in the outer surface 100 formed beneath the shelf 82 accommodates the protuberance 99. By nesting the protuberances 98, 99 on the cover 16 of one trap 10 within the recesses 106, 108 in the base 14 of another trap 10, multiple traps 10 can be stacked in a non-sliding relationship for improved transport and storage capabilities.

The housing 12 of the present invention may be made of metal, such as sheet metal, but is preferably molded of a suitable plastic material in any conventional manner. The selection of the particular plastic material and the manufacturing method used to form the elements, however, is not a critical portion of the instant inventive concepts. A preferred plastic material is acrylonitrile butadiene styrene (ABS) polymer. The trap assemblies 32 included in the housing 12 which define the passageway, including the sides, roof, inclined plane member and door member, are preferably formed of sheet metal.

The ability to form the housing of plastic simplifies the manufacturing of the trap and enables the incorporation of additional features at minimal cost. For example, the upstanding protuberances formed on the outer surface of the cover may be easily formed in the molding process, as may the mounting wells with barriers, fastening mechanism, trap assembly securing projections, etc.

In addition, while the base has been described as a unitary structure including a floor with integrally molded upstanding walls, the walls and the floor could also be manufactured separately and then coupled together. For example, the floor could be made with a connecting structure into which the walls, having a complementary structure, could be secured with a snap fit. Alternatively, the floor element could be slidably received in a channel formed on the inner surfaces of the wall elements. Any connecting system suitable for securing the components together while ensuring that the resulting enclosure is sufficiently “sealed” at the edges so as to prevent pest escape could be employed.

It will now be seen that there is herein provided a repeating animal and pest trap embodiment which is quite versatile in operation, extremely efficient, simple and inexpensive to manufacture and maintain, and which satisfies all of the objects of the instant inventive concepts identified above, and others, including many advantages of great practical utility and commercial importance.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific example disclosed or the exact construction and operation shown and described. Rather, all suitable modifications and equivalents may be resorted to, falling within the scope of the invention.

What is claimed is:

1. An escape-proof, corner-fitting pest trap comprising:
a base having a floor and upstanding walls that define a trap enclosure, two of said walls meeting at substantially a right angle to form a trap corner for positioning the trap in a room corner with each of said two walls being generally parallel with a respective room wall when so positioned, two acess openings in said base for allowing entry of a pest into said trap enclosure, said access openings positioned adjacent ends of said two walls distal from said trap corner so as to be proximal to said room walls;
a pair of inclined plane trap assemblies fitted to said floor within said base, each trap assembly having an entrance aligned with a respective access opening and an exit communicating with said trap enclosure, the inclined plane of each trap assembly configured to prevent a pest that has entered the enclosure through the trap assembly from escaping back through said assembly; and
a cover fitted over the upstanding walls of said base and held in a closed position thereon.

2. The escape-proof, corner-fitting pest trap as set forth in claim 1, wherein said floor includes an upper surface interfacing with the enclosure, and a lower surface interfacing with an external support surface upon which the trap is placed, said upper surface including a pair of mounting wells formed therein for securing the two trap assemblies within the base.

3. The escape-proof, corner-fitting pest trap as set forth in claim 2, wherein each of said mounting wells includes at least one ledge along an inner perimeter thereof, each of said trap assemblies having a flange configured to fit under said ledge to secure said trap assembly within the well.

4. The escape-proof, corner-fitting pest trap as set forth in claim 3, wherein said cover includes two projections on an inner surface thereof, each of said projections contacting an upper surface of a respective trap assembly when the cover is closed to further secure said assembly against said floor.

5. The escape-proof, corner-fitting pest trap as set forth in claim 2, wherein an exit end of said well adjacent said trap assembly exit is sloped upward toward the upper surface of the floor to facilitate pest movement into the enclosure.

6. The escape-proof, corner-fitting pest trap as set forth in claim 2, wherein said upper surface of the floor includes an offset configured to receive a glue board insert.

7. The escape-proof, corner-fitting pest trap as set forth in claim 1, wherein said cover is hingedly connected to a pair of gussets formed on a rear wall extending between said two access openings, said gussets configured to act as a stop to prevent the cover in a fully opened position from touching an external support surface upon which the trap is placed.

8. The escape-proof, corner-fitting pest trap as set forth in claim 7, wherein said rear wall includes a plurality of apertures through which insects are able to enter the enclosure.

9. The escape-proof, corner-fitting pest trap as set forth in claim 8, wherein a tapered ledge extends outwardly from a base of said rear wall beneath said apertures for improved stability of the base on said external support surface.

10. The escape-proof, corner-fitting pest trap as set forth in claim 8, wherein upper and side edges of said apertures are reinforced with a protruding edge.

11. The escape-proof, corner-fitting pest trap as set forth in claim 2, wherein said lower surface of the floor includes raised portions corresponding with the wells, said raised portions defining adjacent recesses that are configured to cooperate with spaced protuberances formed on the cover of another trap to enable multiple traps to be stacked in a non-sliding relationship for storage or transport.

12. The escape-proof, corner-fitting pest trap as set forth in claim 11, wherein said cover is held in a closed position on said side walls by a latching mechanism configured to provide an additional recess in said lower surface that is spaced from said well recesses, said additional recess configured to cooperate with a further cover protuberance positioned adjacent said trap corner.

13. An escape-proof, corner-fitting pest trap comprising:
a floor, generally vertical side walls and a cover that define a trap enclosure;
two of said side walls meeting to form a trap corner for positioning of the trap in a room corner such that each of said two walls is generally parallel with a respective room wall when so positioned, said side walls having access openings for allowing entry of a pest into said trap enclosure, said access openings positioned adjacent ends of said two side walls distal from said trap corner so as to be proximal to said room walls;
a pair of trap assemblies secured within said enclosure, each trap assembly having an entrance aligned with a respective access opening and an exit communicating with said trap enclosure and including an escape-proof mechanism configured to enable pests to enter the enclosure while preventing exit therefrom; and
said cover being held in a closed position with respect to said floor and said side walls by a latching mechanism such that pests entering the trap through the trap assemblies are contained within the enclosure.

14. The escape-proof, corner-fitting pest trap as set forth in claim 13, further comprising a plurality of said pest traps, each pest trap having protuberances formed on an outer surface of said cover and recesses formed in an outer surface of said floor, said protuberances and said recesses being respectively positioned for mutual nesting to enable said plurality of pest traps to be stacked one upon another in non-sliding relationship.

15. The escape-proof, corner-fitting pest trap as set forth in claim 13, wherein said floor includes an upper surface interfacing with the enclosure, and a lower surface interfacing with an external support surface upon which the trap is placed, said upper surface including a pair of mounting wells formed therein for securing the two trap assemblies within said trap enclosure.

16. The escape-proof, corner-fitting pest trap as set forth in claim 15, wherein each of said mounting wells includes at least one ledge along an inner perimeter thereof, each of said trap assemblies having a flange configured to fit under said ledge to secure said trap assembly within the well.

17. The escape-proof, corner-fitting pest trap as set forth in claim 15, wherein said cover includes two projections on an inner surface thereof, each of said projections contacting an upper surface of a respective trap assembly when the cover is closed to secure said assembly against said floor.

18. The escape-proof, corner-fitting pest trap as set forth in claim 13, wherein each of said trap assemblies includes two sides, a roof and an inclined plane member which, together with the floor, define an elongated passageway extending generally parallel with a respective one of said two walls, a plurality of apertures being formed in a rear wall extending between said access openings through which insects are able to enter said enclosure, said floor being configured to receive a replaceable glue board insert that snares said insects within said enclosure.

19. A stackable, escape-proof, corner-fitting pest trap comprising:
a floor, upstanding side walls and a cover that define a trap enclosure, two of said side walls meeting to form a trap corner for positioning of the trap in a room corner, an access opening being formed in at least one of said upstanding side walls for allowing entry of a pest into said trap enclosure;
a trap assembly secured within said enclosure and having an entrance aligned with said access opening and an exit communicating with said trap enclosure, said trap assembly including an escape-proof mechanism that prevents pests from leaving the enclosure once inside; and
said cover including protuberances on an upper surface that nest within corresponding recesses in an outer surface of the floor of another trap, enabling a plurality of said traps to be stacked in non-sliding relationship with one another for storage or transport.

20. The stackable escape-proof, corner-fitting pest trap as set forth in claim 19, wherein said trap assembly is secured within a ledged well formed in said floor, said well forming a corresponding projecting area on said outer surface of the floor that defines said nesting recesses.
